(19) United States
(12) Patent Application Publication
(10) Pub. No.: US 2026/0249190 A1
(43) Pub. Date: Aug. 27, 2026

(54) DEVICE AND METHOD FOR UPGRADING SKILL OF GAME CHARACTER

(71) Applicant: ASUSTeK COMPUTER INC., Taipei City (TW)

(72) Inventors: Chih-Hsien Yang, Taipei City (TW); Yu-Rou Wang, Taipei City (TW); Jung-Cheng Liu, Taipei City (TW)

(73) Assignee: ASUSTeK COMPUTER INC., Taipei City (TW)

(21) Appl. No.: 19/084,797

(22) Filed: Mar. 20, 2025

(30) Foreign Application Priority Data
Feb. 21, 2025 (TW) 114106430

(51) Int. Cl. A63F 13/58; A63F 13/537

(52) U.S. Cl. CPC A63F 13/58; A63F 13/537

(57) ABSTRACT

A device and a method for upgrading a skill of a game character are provided. The method includes following steps. Whether a target game program currently being executed is one of multiple preset game programs is determined. When the target game program is one of the preset game programs and the game character in the target game program meets an upgrade condition, a corresponding skill upgrade path is executed to upgrade at least one skill of the game character.

### CROSS-REFERENCE TO RELATED APPLICATIONS

This application claims the priority benefit of Taiwan application serial no. 114106430, filed on February 21, 2025. The entirety of the above-mentioned patent application is hereby incorporated by reference herein and made a part of this specification.

### BACKGROUND

### Technical Field

The disclosure relates to a device and a method for upgrading a skill of a game character.

### Description of Related Art

Currently, multiplayer online battle arena (MOBA) games have rapidly developed. In this type of game, there are various game characters, and each of the various game characters has different skills. Each time a character level is increased, a player may select one skill to upgrade. However, for new players, it is challenging to become familiar with this complex process.

### SUMMARY

The device for upgrading a skill of a game character of the disclosure includes an application programming interface (API) and a processor. The application programming interface has multiple skill upgrade paths. The skill upgrade paths respectively correspond to multiple preset game programs. Each of the preset game programs includes multiple game characters. Each of the game characters has multiple corresponding character levels and multiple corresponding skills. Each of the skill upgrade paths corresponds to a priority order of the skills selected by the each of the game characters when the each of the game characters is upgraded at a different stage. The processor executes the following steps. Whether a target game program currently being executed is one of the preset game programs is determined. When the target game program is the one of the preset game programs and the game character in the target game program meets an upgrade condition, a corresponding one of the skill upgrade paths is executed to upgrade at least one of the skills of the game character.

A method for upgrading a skill of a game character of the disclosure is adapted for a device including an application programming interface and a processor. The application programming interface has multiple skill upgrade paths. The skill upgrade paths respectively correspond to multiple preset game programs. Each of the preset game programs includes multiple game characters. Each of the game characters has multiple corresponding character levels and multiple corresponding skills. Each of the skill upgrade paths corresponds to a priority order of the skills selected by the each of the game characters when the each of the game characters is upgraded at a different stage. The method includes the following steps. Whether a target game program currently being executed is one of the preset game programs is determined. When the target game program is the one of the preset game programs and the game character in the target game program meets an upgrade condition, a corresponding one of the skill upgrade paths is executed to upgrade at least one of the skills of the game character.

Based on the above, the device and method for upgrading a skill of a game character of the disclosure may automatically execute a skill upgrade path to upgrade a skill of the game character when the target game program is one of the preset game programs and the game character in the target game program meets the upgrade condition. Accordingly, for new players who are unfamiliar with the target game program, the disclosure may reduce the time required to learn the target game program, thereby improving user experience.

To make the features and advantages of the disclosure more comprehensible, several embodiments accompanied with drawings are described in detail as follows.

### BRIEF DESCRIPTION OF THE DRAWINGS

FIG. 1 is a schematic diagram of a device for upgrading a skill of a game character according to an embodiment of the disclosure.

FIG. 2 is a flowchart of a method for upgrading a skill of a game character according to an embodiment of the disclosure.

FIG. 3 is a schematic diagram of a skill upgrade path according to an embodiment of the disclosure.

### DESCRIPTION OF THE EMBODIMENTS

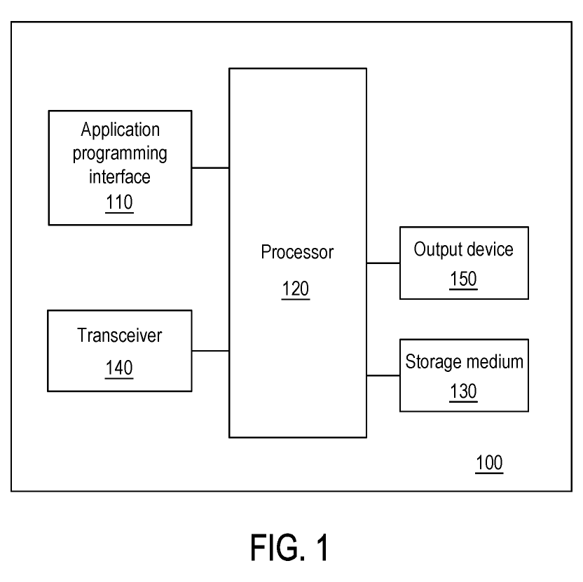

FIG. 1 is a schematic diagram of a device 100 for upgrading a skill of a game character according to an embodiment of the disclosure. In this embodiment, the device 100 may include an application programming interface (API) 110 and a processor 120. In other embodiments, the device 100 may include a storage medium 130 coupled to the processor 120. In other embodiments, the device 100 may include a transceiver 140 coupled to the processor 120. In other embodiments, the device 100 may include an output device 150 coupled to the processor 120.

The processor 120 may be, for example, a central processing unit (CPU) or another programmable general-purpose or special-purpose micro control unit (MCU), microprocessor, digital signal processor (DSP), programmable controller, application-specific integrated circuit (ASIC), graphics processing unit (GPU), image signal processor (ISP), image processing unit (IPU), arithmetic logic unit (ALU), complex programmable logic device (CPLD), field programmable gate array (FPGA), or another similar element or a combination of the above elements. The processor 120 may access and execute multiple modules and various applications stored in the storage medium 130.

The storage medium 130 may be, for example, any type of fixed or removable random access memory (RAM), read-only memory (ROM), flash memory, hard disk drive (HDD), solid-state drive (SSD), or another similar element or a combination of the above elements.

The transceiver 140 transmits and receives signals in a wired or wireless manner.

The output device 150 may include various output devices such as a screen and a touch panel.

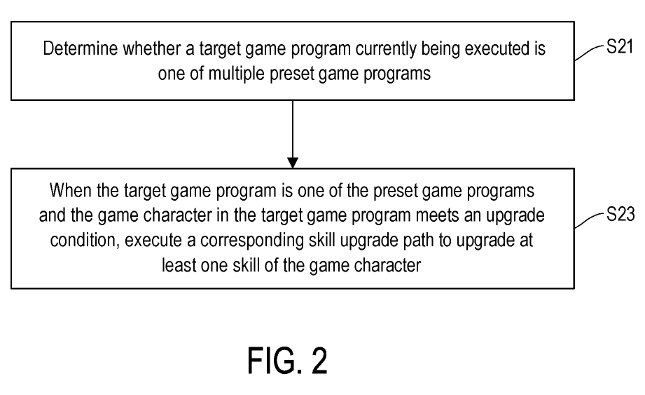

FIG. 2 is a flowchart of a method for upgrading a skill of a game character according to an embodiment of the disclosure, wherein the method may be implemented by the device 100 shown in FIG. 1. Please refer to both FIG. 1 and FIG. 2. In this embodiment, the application programming interface 110 may have a plurality of skill upgrade paths, which may respectively correspond to a plurality of preset game programs. Each of the plurality of preset game programs may include a plurality of game characters. Each of the plurality of game characters may have a plurality of corresponding character levels and a plurality of corresponding skills. Each of the plurality of skill upgrade paths corresponds to a priority order of the plurality of skills selected by each of the plurality of game characters when each of the plurality of game characters is upgraded at a different stage.

In an embodiment, the storage medium 130 may store the plurality of skill upgrade paths. In another embodiment, the processor 120 may receive the plurality of skill upgrade paths through the transceiver 140. In other words, the processor 120 may obtain the plurality of skill upgrade paths by downloading.

Referring to FIG. 2 again, in step S21, the processor 120 may determine whether a target game program currently being executed is one of the plurality of preset game programs. In an embodiment, the processor 120 determines whether the target game program is one of the plurality of preset game programs through a game screen of the target game program. For example, the processor 120 may analyze the game screen of the target game program to determine whether the target game program currently being executed is one of the plurality of preset game programs.

In step S23, when the target game program is one of the plurality of preset game programs and the game character in the target game program meets an upgrade condition, the processor 120 may execute the corresponding skill upgrade path to upgrade at least one of the plurality of skills of the game character. In an embodiment, when the character level is upgraded to a highest character level, the processor 120 may stop upgrading the at least one skill.

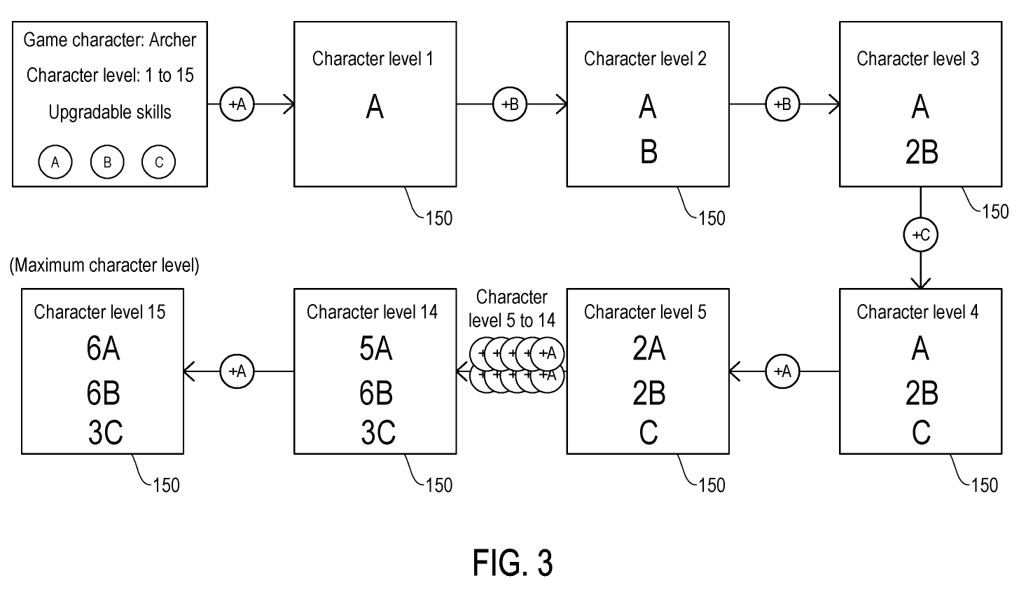

FIG. 3 is a schematic diagram of a skill upgrade path according to an embodiment of the disclosure. Please refer to FIG. 1, FIG. 2, and FIG. 3 together. In this embodiment, it is assumed that the processor 120 has determined that the target game program currently being executed is one of the plurality of preset game programs. It is further assumed that the game characters of the target game program include a “Mage,” an “Archer,” a “Warrior,” and an “Assassin.” Furthermore, it is assumed that the game character “Archer” has a plurality of corresponding character levels (character level 1 to character level 15) and a plurality of corresponding skills (skill A, skill B, and skill C).

It is assumed that the game character “Archer” has met the upgrade condition. As shown in FIG. 3, the processor 120 may execute the corresponding skill upgrade path to upgrade at least one skill of the game character “Archer.” Specifically, the skill upgrade path may be as follows:

When the game character is upgraded to character level 1 for the first time, skill A is automatically upgraded.

When character level 1 is upgraded to character level 2, skill B is automatically upgraded.

When character level 2 is upgraded to character level 3, skill B is automatically upgraded.

When character level 3 is upgraded to character level 4, skill C is automatically upgraded.

In such manner, until when character level 14 is upgraded to character level 15, skill A is automatically upgraded.

Accordingly, even if a new player is not familiar with the target game program, the new player may still automatically upgrade the skills of the game character through the skill upgrade path of the disclosure.

It should be noted that, although FIG. 3 illustrates the game character “Archer” in the target game program having 15 character levels and 3 skills, the disclosure is not limited thereto.

In summary, the device and method for upgrading a skill of a game character of the disclosure may automatically execute a skill upgrade path to upgrade a skill of the game character when the target game program is one of the plurality of preset game programs and the game character in the target game program meets the upgrade condition. Accordingly, for new players who are unfamiliar with the target game program, the disclosure may reduce the time required to learn the target game program, thereby improving user experience.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A device for upgrading a skill of a game character, comprising:
an application programming interface, having a plurality of skill upgrade paths, wherein the plurality of skill upgrade paths respectively correspond to a plurality of preset game programs, each of the plurality of preset game programs comprises a plurality of game characters, each of the plurality of game characters has a plurality of corresponding character levels and a plurality of corresponding skills, and each of the plurality of skill upgrade paths corresponds to a priority order of the plurality of skills selected by the each of the plurality of game characters when the each of the plurality of game characters is upgraded at an different stage; and
a processor, the processor executing:
determining whether a target game program currently being executed is one of the plurality of preset game programs; and
when the target game program is the one of the plurality of preset game programs and the game character in the target game program meets an upgrade condition, executing a corresponding one of the plurality of skill upgrade paths to upgrade at least one of the plurality of skills of the game character.

2. The device according to claim 1, wherein the processor determines whether the target game program is the one of the plurality of preset game programs through a game screen of the target game program.

3. The device according to claim 1, wherein
when the character level is upgraded to a maximum character level, the processor stops upgrading the at least one of the plurality of skills.

4. The device according to claim 1, further comprising a storage medium, coupled to the processor, wherein the storage medium stores the plurality of skill upgrade paths.

5. The device according to claim 1, further comprising a transceiver, coupled to the processor, wherein the processor receives the plurality of skill upgrade paths through the transceiver.

6. A method for upgrading a skill of a game character, adapted for a device comprising an application programming interface and a processor, wherein the application programming interface has a plurality of skill upgrade paths, the plurality of skill upgrade paths respectively correspond to a plurality of preset game programs, each of the plurality of preset game programs comprises a plurality of game characters, each of the plurality of game characters has a plurality of corresponding character levels and a plurality of corresponding skills, and each of the plurality of skill upgrade path corresponds to a priority order of the plurality of skills selected by the each of the plurality of game characters when the each of the plurality of game characters is upgraded at a different stage, wherein the method comprises:
determining whether a target game program currently being executed is the one of the plurality of preset game programs; and
when the target game program is the one of the plurality of preset game programs and the game character in the target game program meets an upgrade condition, executing a corresponding one of the plurality of skill upgrade paths to upgrade at least one of the plurality of skills of the game character.

7. The method according to claim 6, wherein determining whether the target game program currently being executed is the one of the plurality of preset game programs comprises:
determining whether the target game program is the one of the plurality of preset game programs through a game screen of the target game program.

8. The method according to claim 6, further comprising:
when the character level is upgraded to a maximum character level, stopping upgrading the at least one of the plurality of skills.
